(19) United States
(12) Patent Application Publication
(10) Pub. No.: US 2017/0353017 A1
(43) Pub. Date: Dec. 7, 2017

(54) PULLING DEVICE ATTACHMENT

(71) Applicant: Andy Ward, Papillion, NE (US)

(72) Inventor: Andy Ward, Papillion, NE (US)

(21) Appl. No.: 15/615,015

(22) Filed: Jun. 6, 2017

Related U.S. Application Data
(60) Provisional application No. 62/346,649, filed on Jun. 7, 2016.

(51) Int. Cl. H02G 1/08; D07B 1/18; D07B 1/00

(52) U.S. Cl. CPC H02G 1/081; D07B 1/005; D07B 1/185

(57) ABSTRACT

Aspects of the disclosure relate to a pulling device for pulling wire, cable, and/or duct products through an opening (e.g., bore, conduit, duct, etc.). The pulling device includes a gripping sleeve having a first end and a second end, the first end of the gripping sleeve configured to receive the product. The second end of the gripping sleeve is coupled with an eye, the eye configured to guide the pulling device through the opening. The pulling device further includes a cord configured to remove a protective material that can at least partially enclose the gripping sleeve and/or the product. The cord can be coupled to at least one of the gripping sleeve or the eye, and extend distally beyond the first end of the gripping sleeve.

### CROSS-REFERENCE TO RELATED APPLICATIONS

The present application claims the benefit under 35 U.S.C. §119(e) of U.S. Provisional Application Ser. No. 62/346,649, entitled PULLING DEVICE ATTACHMENT, filed on Jun. 7, 2016. U.S. Provisional Application Ser. No. 62/301,285 is herein incorporated by reference in their entireties.

### BACKGROUND

Pulling grips are used for pulling overhead or underground cable, for stringing service or communication lines into buildings, for pulling wire through conduit, and for general underground construction.

### SUMMARY

Aspects of the disclosure relate to a pulling device for pulling wire, cable, and/or duct products through an opening (e.g., bore, conduit, duct, etc.). The pulling device includes a gripping sleeve having a first end and a second end, the first end of the gripping sleeve configured to receive the product. The second end of the gripping sleeve is coupled with an eye, the eye configured to guide the pulling device through the opening. The pulling device further includes a cord configured to remove a protective material that can at least partially enclose the gripping sleeve and/or the product. The cord can be coupled to at least one of the gripping sleeve or the eye, and extend distally beyond the first end of the gripping sleeve.

In some embodiments, the cord includes a looped end. The looped end can be configured for receiving a locating wire. The looped end can be coupled to a swivel. The swivel can bias the locating wire in respect to the gripping sleeve and/or the product, minimizing tangling of the locating wire around the product.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. The use of the same reference numbers in different instances in the description and the figures can indicate similar or identical items.

FIG. 1 is a top view illustrating a pulling device in accordance with embodiments of the present disclosure.

FIG. 2 is a top view illustrating an eye of a pulling device, such as the pulling illustrated in FIG. 1, in accordance with embodiments of the present disclosure.

FIG. 3A is a top view illustrating the cord of a pulling device, such as the pulling device illustrated in FIG. 1, in accordance with embodiments of the present disclosure.

FIG. 3B is a top view illustrating the cord of a pulling device, such as the pulling device illustrated in FIG. 1, the cord including a swivel in accordance with embodiments of the present disclosure.

FIG. 4A is a top view illustrating a pulling device, such as the pulling device illustrated in FIG. 1, including a product received by the pulling device in accordance with example embodiments of the present disclosure.

FIG. 4B is a top view illustrating a pulling device, such as the pulling device illustrated in FIG. 1, including a protective material in accordance with example embodiments of the present disclosure.

FIG. 4C is a top view illustrating a pulling device, such as the pulling device illustrated in FIG. 1, the cord of the pulling device being configured to remove a protective material.

FIG. 4D is another top view illustrating a pulling device, such as the pulling device illustrated in FIG. 1, the cord of the pulling device being configured to remove a protective material.

FIG. 5 is a flow diagram illustrating an example method for removing a protective material from a pulling device in accordance with embodiments of the present disclosure.

### DETAILED DESCRIPTION

Overview

Pulling devices (e.g., pulling grips, cable eyes, etc.) serve as reusable tools for pulling wire or cable products, such as conductors, bare wires, insulated wires, fiber optic cable, nylon and wire rope, and so forth, through bores and/or conduits. Pulling grips are utilized for overhead, underground, or in-plant wiring applications.

Once the product is inserted into the pulling grip, the pulling grip can be wrapped in a protective material (e.g., an adhesive tape). Wrapping the pulling grip with tape prevents the wire or cable product from catching and/or snagging while being pulled through rough or uneven surfaces, reducing damage to or loss of product. While the tape is useful in protecting the wire product and preventing product loss, it can create additional problems. For example, the tape can be difficult to remove. The tape must typically be removed with a knife, which can result in damage to the product or to the pulling grip. Removing the tape can also be damaging to the user's hands, particularly if a knife is used to cut the tape and the pulling grip, resulting in metallic spurs along the pulling grip that can damage the user's hands. Further, the pulling grip often becomes very muddy or dirty during use, making the tape difficult to locate and wasting valuable time of the user. Additionally, locating wires used in conjunction with the pulling grip often become tangled around the grip or the product, resulting in loss of product.

A pulling device for pulling wire, cable, and/or duct products through an opening (e.g., bore, conduit, duct, etc.) is described. The pulling device includes a gripping sleeve having a first end and a second end, the first end of the gripping sleeve configured to receive the product. The second end of the gripping sleeve is coupled with an eye, the eye configured to guide the pulling device through the opening. The pulling device further includes a cord configured to remove a protective material that can at least partially enclose the gripping sleeve and/or the product. The cord can be coupled to at least one of the gripping sleeve or the eye, and extend distally beyond the first end of the gripping sleeve.

Example Embodiments

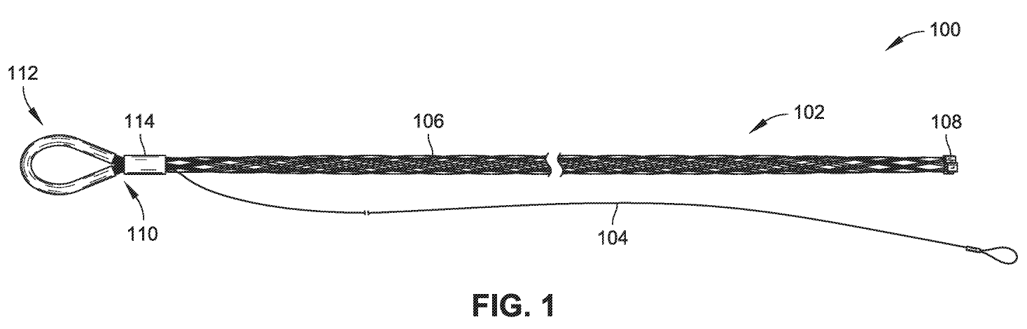

Referring to FIGS. 1 through 4D, pulling devices 100 configured to facilitate the pulling of a cable and/or wire product through a bore or conduit are described.

Referring now to FIG. 1, the pulling device includes a grip 102 (e.g., a Kellum grip) and a cord 104. The grip 102 comprises a gripping sleeve 106 configured to receive one or more products (e.g., wires, cables, ducts, pipes, etc.; not shown). The product can comprise a variety of materials including, but not necessarily limited to: bare wire, insulated wire, cable, fiber optic cable, nylon and wire rope, ducting, and so forth.

In embodiments, the gripping sleeve 106 can comprise a braided wire tube configured for receiving the product. For example, the tube can form a lumen into which the product can be inserted. The gripping sleeve 106 can comprise a durable wire mesh material such as steel mesh, galvanized steel mesh, or another suitable mesh material, or other materials including, but not limited to, aramid fiber (e.g., a plastic coated aramid fiber). A variety of meshes can be used including, but not necessarily limited to: closed mesh, split mesh, single weave mesh, double weave mesh, triple weave mesh, quadruple weave mesh, and so forth. The mesh type can be selected based on the desired use of the pulling device 100. For example, single weave mesh can be utilized for light duty applications, and double weave mesh or greater weaved meshes can be utilized for heavy duty applications. Likewise, a closed mesh can be selected for applications where the end of the product is accessible, while split mesh can be selected for applications where the end of the product is not accessible. The length of the gripping sleeve 106 can also be selected based on the desired use of the pulling device. For example, increasing the length of the gripping sleeve 106 can increase the gripping strength 106. The diameter or cross-sectional area of the gripping sleeve 106 can be selected based on the diameter or size of the product. In some embodiments, the gripping sleeve 106 can have a diameter or cross-sectional area that is greater than the product in a first configuration, and a diameter or cross-sectional area that is smaller than the product in a second configuration. This configuration can facilitate receiving and gripping of the product by the gripping sleeve 106. For example, when two sections of the gripping sleeve 106 (e.g., two ends, an end and an intermediate portion, etc.) are pushed together, the diameter or cross-sectional area of the gripping sleeve 106 increases to receive the product. Alternatively, when the ends of the gripping sleeve 106 are pulled apart, the diameter or cross-sectional area decreases, gripping the product.

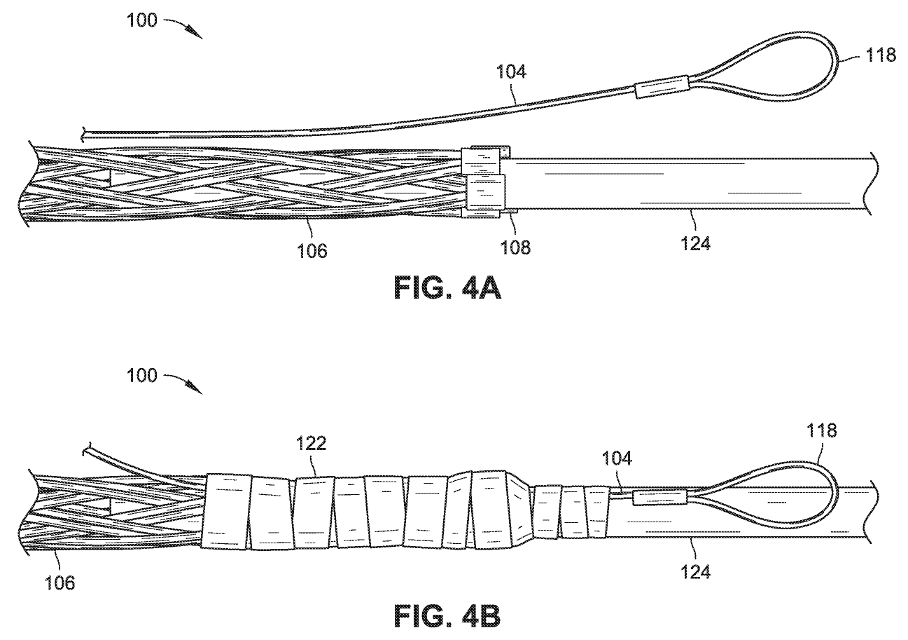

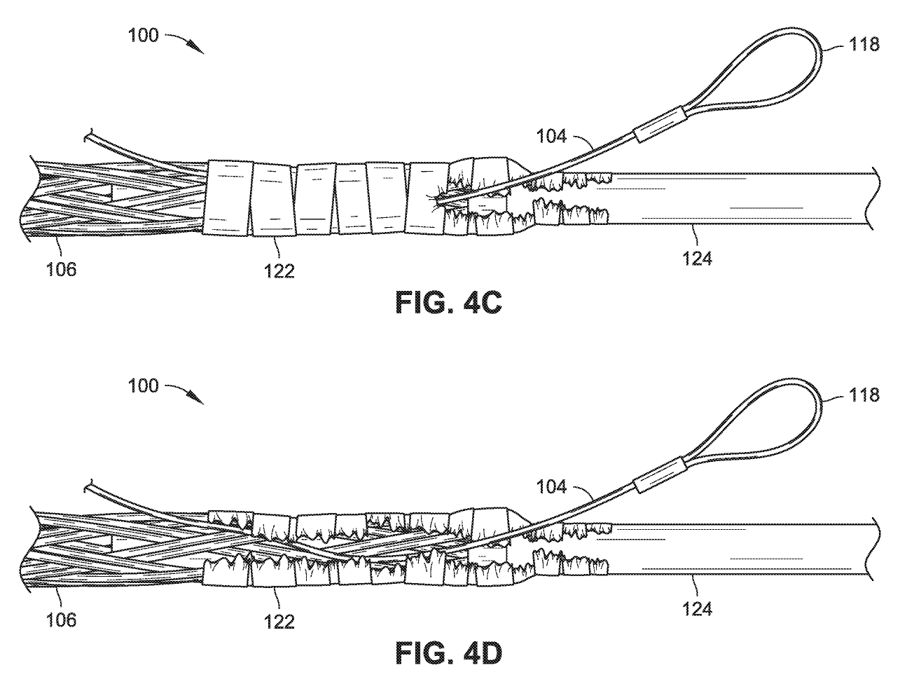

In embodiments, the gripping sleeve 106 includes a first end 108 and a second end 110. The first end 108 is configured to receive the product. For example, the first end 108 can comprise a distal open end that is placed over the product (e.g., as described with reference to FIGS. 4A through 4D). The second end 110 of the gripping sleeve 102 is coupled to an eye 112. For example, the second end 110 can comprise a proximal end that closes the lumen of the gripping sleeve 106 by terminating in or otherwise coupling with the eye 112. The eye 112 comprises a loop configured for guiding the gripping sleeve 106 through an opening (e.g., bore, conduit, duct, pipe, etc.). In some implementations, the eye 112 can be configured to receive a rope, cable, and/or hook to facilitate pulling of the pulling device 100. The eye 112 can be formed from a durable material such as wire, wire rope, and so forth. In some embodiments, the eye 112 can be fixedly or rotatably coupled to the gripping sleeve 106. For example, the eye 112 can be coupled to the gripping sleeve 106 by a connector 114 (e.g., a knuckle). In some embodiments, the connector 114 may comprise a point of connection between the eye 112 and the gripping sleeve 106. In some embodiments, the eye 112 can be formed from the gripping sleeve 106 or materials therefrom. For example, the connector 114 may comprise a guide for directing the wire of the gripping sleeve 106 into a loop, forming the eye 112.

Still referring to FIG. 1, the cord 104 can be coupled to the grip 102. In embodiments, the cord 104 can be fixedly or removably coupled to the gripping sleeve 106 and/or the eye 112. In embodiments, the cord 104 is configured to extend distally from a point of attachment on the gripping sleeve 106 and/or the eye 112. The cord 104 is configured to span lengthwise along the gripping sleeve 106. Thus, the length of the cord 104 can vary with the length of the gripping sleeve 106. In some embodiments, the cord 104 is configured to extend distally beyond the first end 108 of the gripping sleeve 106. The cord 104 can comprise a durable material such as wire (e.g., metallic wire), wire rope, a synthetic material, an aramid fiber (e.g., a coated aramid fiber), twine (e.g., natural twine) and so forth. The cord 104 can include a coating, such as a coating to protect and/or strengthen the material of the cord 104. In exemplary embodiments, the cord 104 comprises a wire suitable for up to 400 lb duty.

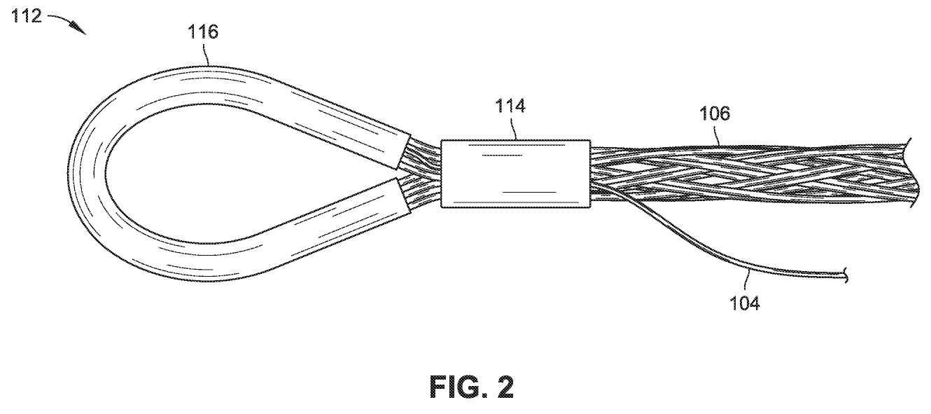

Referring now to FIG. 2, the cord 104 can be coupled to the gripping sleeve 106 and/or the eye 112. It is contemplated that the cord 104 can be coupled to the gripping sleeve 106 and/or the eye 112 in a variety of ways. In some embodiments, the eye 112 can include a casing 116 configured to enclose at least a portion of the cord 104 and couple the cord 104 with the eye 112. In other embodiments, the cord 104 can be coupled to the gripping sleeve by the connector 114. In still other embodiments, the cord 104 can be coupled directly to the gripping sleeve 106 and/or the eye 102. For example, the cord 104 can be crimped (e.g., where connector 114 includes a crimped connection) or braided into the mesh.

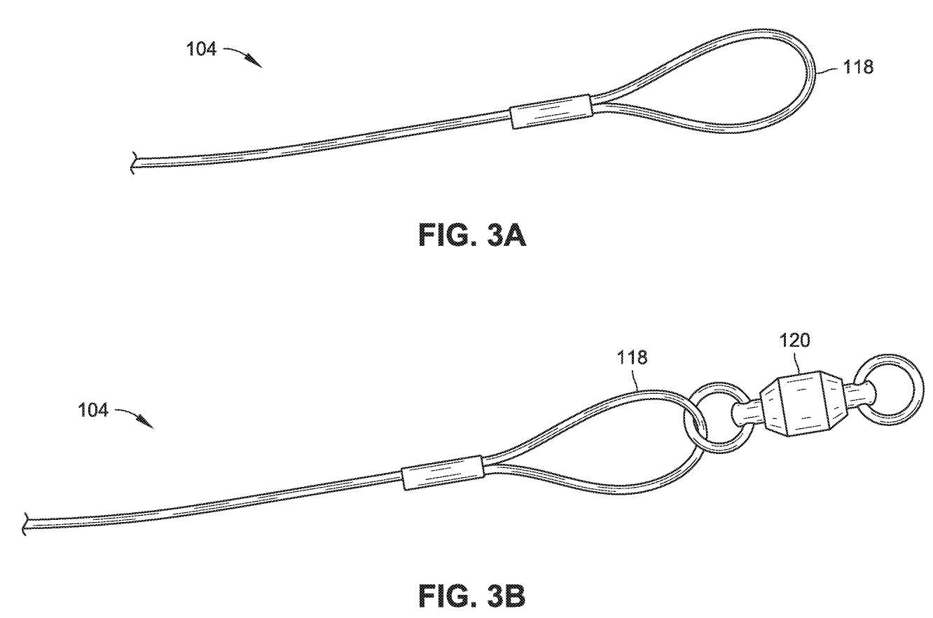

Referring now to FIGS. 3A and 3B, the cord 104 can include a looped end 118 configured to facilitate pulling of the cord 104. The looped end 118 can also facilitate attachment of a locating wire (e.g. tracer wire). In implementations, the locating wire can be removably attached to the looped end 118. In some implementations, the locating wire can be coupled directly to the cord 104. In other implementations, the cord 104 can include a swivel 120 for rotatably coupling the cord 104 to the locating wire (e.g., as described with reference to FIG. 3B). The rotational movement of the swivel 118 can prevent the locating wire from becoming biased with respect to the gripping sleeve, allowing the locating wire to be pulled through the opening with the product without becoming snagged or tangled. The size (e.g., gauge) of the locating wire can be selected based on the intended use. In some implementations, the locating wire comprises 12 gauge wire. The locating wire can comprise a variety of materials including, but not necessarily limited to: copper clad steel, copper, coated copper, stainless steel, stranded copper, stranded stainless steel, and so forth. In implementations, the locating wire can be pulled through the bore or conduit with the product to identify the location of the product (e.g., for future locating of the product after the product is buried). For example, the locating wire can be pulled through a bore with a duct, identifying the location of the duct for future cable installation. Because the locating wire is removably coupled to the cord, the locating wire can be disconnected without removing the product from the pulling device 100.

Referring now to FIGS. 4A through 4D, the cord 104 is configured to remove (e.g., tear, rip, etc.) the protective material (e.g., tape 122) from the gripping sleeve 106. Enclosing the gripping sleeve 106 with tape 122 can enhance the gripping ability of the gripping sleeve 106, and can prevent loss of product 124 during pulling. For example, tape 122 can prevent the product 124 from snagging, catching, or protruding from the mesh during pulling. When a product 124 is inserted in the gripping sleeve 106, the cord 104 can extended distally beyond the first end 108 of the gripping sleeve 106 (e.g., as described with reference to FIG. 4A). For example, the looped end 118 can extend distally beyond the first end 108 of the gripping sleeve 106 and overlap the product 124. When tape 122 is applied to the gripping sleeve 106, the cord 104 can also be enclosed beneath the tape 122, leaving the looped end 118 exposed and protruding beyond the first end 108 of the gripping sleeve 106 (e.g., as described with reference to FIG. 4B). For example, the cord 104 can be positioned flush against the gripping sleeve 106 and the product 124. The tape 122 can overlap the product 124, which can help to hold the product 124 in place within the gripping sleeve 106. When the looped end 118 is pulled axially towards the second end 110 of the gripping sleeve 106, the cord 104 will tear or rip through the tape 122, removing the tape 122 from the gripping sleeve 106 (e.g., as described with reference to FIGS. 4C and 4D). Use of the cord 104 permits removal of the tape 122 without the use of a cutting implement (e.g., knife) and without directly removing the tape by hand. Thus, the cord 104 can prevent damage to the pulling device 100, the product 124, and the user's hands. For example, if a knife is used to cut the tape 122 and/or the grip 102 instead of the cord 104, surface irregularities such as metallic spurs can result along the grip 102 due to interaction between the knife blade and the material of the grip 102 that can damage the user's hands (e.g., when stripping the cut tape from the grip 102 and product 124).

Example Method

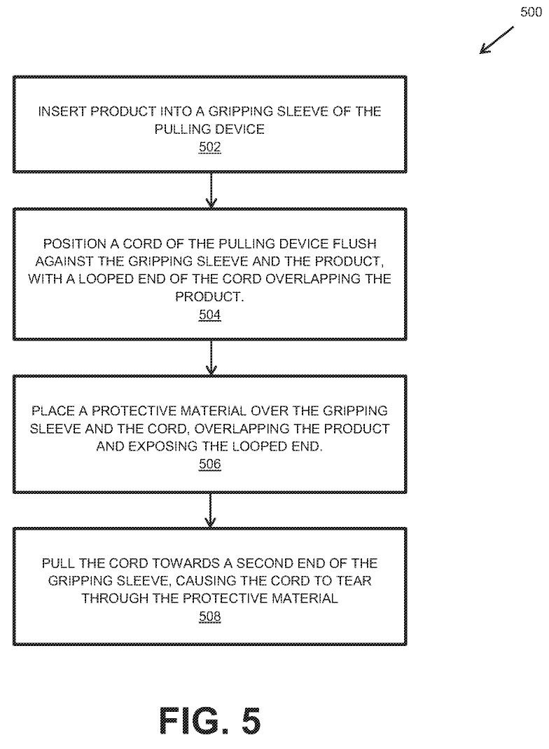

FIG. 5 illustrates an example method 500 that employs a pulling device with a cord for removing a protective material, such as the pulling device 100 shown in FIGS. 1 through 4D.

In the method 500 illustrated, a product is inserted into a gripping sleeve of the pulling device (Block 502). In embodiments, the product 124 can comprise a variety of cable or wire products including, but not necessarily limited to: bare wire, insulated wire, cable, fiber optic cable, nylon and wire rope, ducting, and so forth. The product can be inserted into a first end 108 (e.g., a distal open end) of the gripping sleeve 106. In some embodiments, the gripping sleeve 106 can have a diameter or cross-sectional area that is greater than the product in a first configuration, and a diameter or cross-sectional area that is smaller than the product in a second configuration. This configuration can facilitate receiving and gripping of the product by the gripping sleeve 106. For example, when the ends of the gripping sleeve 106 are pushed together, the diameter or cross-sectional area of the gripping sleeve 106 increases to receive the product. Alternatively, when the ends of the gripping sleeve 106 are pulled apart, the diameter or cross-sectional area decreases, gripping the product. A cord of the pulling device is positioned flush against the gripping sleeve and the product, with the looped end overlapping the product (Block 504). For example, the cord 104 can be positioned parallel to the gripping sleeve 106 and/or the product 124. In embodiments, the cord 104 extends distally from the gripping sleeve 106 (e.g., from a proximal second end 110 of the gripping sleeve 106, or a point of attachment along the gripping sleeve 106), and beyond the first end 108, overlapping the product 124.

A protective material (e.g., tape) is positioned over the gripping sleeve and the cord, overlapping the product and leaving the looped end exposed (Block 506). The exposed looped end 118 facilitates pulling of the cord 104.

The cord is pulled towards a second end of the gripping sleeve, causing the cord to tear through the protective material (Block 508). For example, the cord 104 is pulled axially towards the point of attachment. The tape 122 is thus removed from the gripping sleeve 106 without the use of a knife or other tools.

Conclusion

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A pulling device comprising:
a gripping sleeve having a first end and a second end, the first end of the gripping sleeve configured to receive at least one of a wire product, a cable product, or a duct;
an eye coupled to the gripping sleeve, the eye configured to guide the pulling device through an opening; and
a cord coupled to at least one of the gripping sleeve or the eye, the cord extending distally beyond the first end of the gripping sleeve, the cord configured to remove a protective material that can at least partially enclose at least one of the gripping sleeve or the at least one of a wire product, a cable product, or a duct.

2. The pulling device as recited in claim 1, further comprising a locating wire configured to identify the location of the at least one of a cable product, a wire product, or a duct.

3. The pulling device as recited in claim 1, wherein the opening comprises at least one of a bore, a conduit, a pipe, or a duct.

4. The pulling device as recited in claim 1, wherein the protective material comprises tape.

5. The pulling device as recited in claim 1, wherein the cord comprises at least one of a metallic wire, a synthetic material, an aramid fiber, or a twine.

6. The pulling device as recited in claim 1, wherein the protective material extends distally beyond the first end of the gripping sleeve to at least partially enclose the at least one of a wire product, a cable product, or a duct when the at least one of a wire product, a cable product, or a duct is received by the gripping sleeve.

7. The pulling device as recited in claim 1, wherein the cord further includes a swivel coupled with an end of the cord, the swivel configured for attaching a locating wire.

8. A pulling device comprising:
a gripping sleeve comprising a tube having a proximal end and a distal end, the distal end comprising an open end for receiving at least one of a wire product, a cable product, or a duct;
an eye positioned near the proximal end of the tube, the eye configured to guide the pulling device through an opening; and
a cord coupled to at least one of the gripping sleeve or the eye, the cord including a looped end configured to extend beyond the distal end of the gripping sleeve, the cord configured to remove a protective material that can at least partially enclose at least one of the gripping sleeve or at the least one of a wire product, a cable product, or a duct.

9. The pulling device as recited in claim 8, further comprising a locating wire configured to identify the location of the at least one of a cable product, a wire product, or a duct.

10. The pulling device as recited in claim 8, wherein the opening comprises at least one of a bore, a conduit, a pipe, or a duct.

11. The pulling device as recited in claim 8, wherein the protective material comprises tape.

12. The pulling device as recited in claim 8, wherein the cord comprises at least one of a metallic wire, a synthetic material, an aramid fiber, or a twine.

13. The pulling device as recited in claim 8, wherein the protective material extends beyond the distal end of the gripping sleeve to at least partially enclose the at least one of a wire product, a cable product, or a duct when the at least one of a wire product, a cable product, or a duct is received by the gripping sleeve.

14. The pulling device as recited in claim 8, wherein the cord further includes a swivel coupled with an end of the cord, the swivel configured for attaching a locating wire.

15. A pulling device comprising:
a gripping sleeve having a first end and a second end, the first end of the gripping sleeve configured to receive at least one of a wire product, a cable product, or a duct;
an eye coupled to the gripping sleeve, the eye configured to guide the pulling device through an opening;
a cord coupled to at least one of the gripping sleeve or the eye, the cord including a looped end configured to extend distally beyond the first end of the gripping sleeve, the cord configured to remove a protective material that can at least partially enclose at least one of the gripping sleeve or the at least one of a wire product, a cable product, or a duct; and
a swivel coupled with the looped end of the cord, the swivel configured for attaching a locating wire.

16. The pulling device as recited in claim 15, wherein the locating wire is configured to identify the location of the at least one of a cable product, a wire product, or a duct.

17. The pulling device as recited in claim 15, wherein the opening comprises at least one of a bore, a conduit, a pipe, or a duct.

18. The pulling device as recited in claim 15, wherein the cord comprises at least one of a metallic wire, a synthetic material, an aramid fiber, or a twine.

19. The pulling device as recited in claim 15, wherein the protective material extends beyond the first end of the gripping sleeve to at least partially enclose the at least one of a wire product, a cable product, or a duct when the at least one of a wire product, a cable product, or a duct is received by the gripping sleeve.

20. The pulling device as recited in claim 15, wherein the swivel is configured to bias the locating wire with respect to at least one of the gripping sleeve or the product.
